(19) United States
(12) Patent Application Publication
(10) Pub. No.: US 2015/0159560 A1
(43) Pub. Date: Jun. 11, 2015

(54) SYSTEM AND METHOD FOR EXTRACTING FOREIGN MATTER IN GAS TURBINE

(71) Applicant: GENERAL ELECTRIC COMPANY, Schenectady, NY (US)

(72) Inventors: Anurag Kumar, Clifton Park, NY (US); Chiong Siew Tan, Schenectady, NY (US); Niranjan Talanjeri Shankaranarayana, Bangalore (IN); Vilas Kawaduji Bokade, Bangalore (IN)

(73) Assignee: GENERAL ELECTRIC COMPANY, Schenectady, NY (US)

(21) Appl. No.: 14/097,561

(22) Filed: Dec. 5, 2013

(51) Int. Cl. F02C 9/18

(52) U.S. Cl. CPC F02C 9/18

(57) ABSTRACT

A system for extracting foreign matter in a gas turbine is provided. The system includes a variable bleed valve (VBV) disposed between a booster and a high pressure compressor configured to bleed at least a first flow from a core engine flow path into a bypass flow path to extract foreign particles. The system also includes a wedge structure disposed in the core engine flowpath proximate to the variable bleed valve and configured to allow the at least first flow into the bypass flow path through an extraction passage or at least a second flow through a recovery passage into the core engine flow path.

### BACKGROUND

The present technology relate generally to gas turbine engines and, more specifically, to a system and method for extracting foreign matter in gas turbine engines.

Gas turbine engines typically include a compression system, which may consist of a single compressor or multiple compressors rotating at different speeds, for compressing a working fluid, such as air. The compressed air is channeled into a combustor wherein it is mixed with fuel and ignited to generate combustion gases which are channeled to a turbine. The turbine extracts energy from the combustion gasses to power the compressor, as well as to produce useful work to propel an aircraft in flight, or power a load, such as an electrical generator or a ship propeller. The compression system includes variable bleed valves (VBVs) disposed in a fan hub frame having doors that open to primarily provide improved stability of high pressure compressor and secondly a bleed path to bleed off compressed air between a booster (low pressure compressor) and a core engine compressor for extracting foreign matter such as sand, ice and the like. The problem associated with conventional bleed valve ducts and valve doors is that larger particles and amounts of particles such as sand, ice and the like are often not sufficiently drawn into the bleed duct. This may further cause erosion and generate stresses in compressor vanes and blades. Further the gas turbine engines can suffer from combustion instability problems when large quantities of ice particles enter the core particularly when the engine is being operated at low power and low thrust operating conditions which are established when the engine is operated at idle.

There is therefore a desire for a system and method for an enhanced technique for extracting foreign matter in the core engine flow path in gas turbine engines.

### BRIEF DESCRIPTION

In accordance with an example of the present technology, a system for extracting foreign matter in a gas turbine includes a wedge structure disposed in the core engine flow path between a low pressure compressor and a high pressure compressor and disposed within a fan hub frame. The system also includes an extraction passage formed by a first portion of an upper casing and the wedge structure for allowing a first flow into a bypass flow path for extraction of foreign particles. The system further includes a recovery passage formed by a second portion of the upper casing and the wedge structure for allowing a second flow into the core engine flow path; wherein the second flow is a portion of the first flow.

In accordance with an example of the present technology, a method includes directing at least a first flow from a core engine flow path through an extraction passage formed by a first portion of an upper casing of a gas turbine and a wedge structure into a bypass flow path. The wedge structure is disposed in the core engine flow path between a booster and a high pressure compressor. The method also includes directing at least a second flow through a recovery passage formed by a second portion of the upper casing and the wedge structure into the core engine flow path.

In accordance with an example of the present technology, a system for extracting foreign matter in a gas turbine includes a variable bleed valve (VBV) disposed between a booster and a high pressure compressor configured to bleed at least a first flow from a core engine flow path into a bypass flow path configured to extract foreign particles. The system also includes a wedge structure disposed in the core engine flow path proximate to the variable bleed valve and configured to allow the first flow into the bypass flow path through an extraction passage and at least a second flow through a recovery passage into the core engine flow path.

In accordance with an example of the present technology, a variable bleed valve system includes a variable bleed valve (VBV) door disposed between a booster and a high pressure compressor of a gas turbine for bleeding at least a first flow from a core engine flow path into a bypass flow path for extracting foreign particles. The variable bleed valve system further includes a wedge structure disposed in the core engine flow path proximate to the variable bleed valve for controlling fluid flows in one or more passages formed by the wedge structure with a section of the gas turbine and the variable bleed valve (VBV) door. The one or more passages includes an extraction passage configured for extracting particulate matter by allowing at least the first flow into the bypass flow path and a recovery passage configured for allowing at least a second flow into one or more engine sections of the gas turbine.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view a section of a gas turbine engine showing a core engine flow path having a system for extracting foreign particles in accordance with an example of the present technology;

FIG. 2 is another schematic view a section of a gas turbine engine showing one variable bleed valve door along with wedge structure in accordance with an example of the present technology;

FIG. 3 shows a system for extracting foreign matter in a gas turbine in accordance with another example of the present technology;

FIG. 4 shows a wedge structure of the gas turbine engine in accordance with an example of the present technology;

FIG. 5 shows a wedge structure of the gas turbine engine in accordance with another example of the present technology;

FIG. 6 shows a wedge structure hinged at a downstream end of the core engine flow path of the gas turbine engine in accordance with another example of the present technology;

FIG. 7 shows a wedge structure hinged at an upstream end of the core engine flow path of the gas turbine engine in accordance with another example of the present technology;

FIG. 8 shows a wedge structure of the gas turbine engine in accordance with another example of the present technology;

FIG. 9 is a flow chart of a method of extracting foreign particles by a gas turbine engine in accordance with an example of the present technology.

FIG. 10 is another flow chart of a method of extracting foreign particles by a gas turbine engine in accordance with an example of the present technology.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

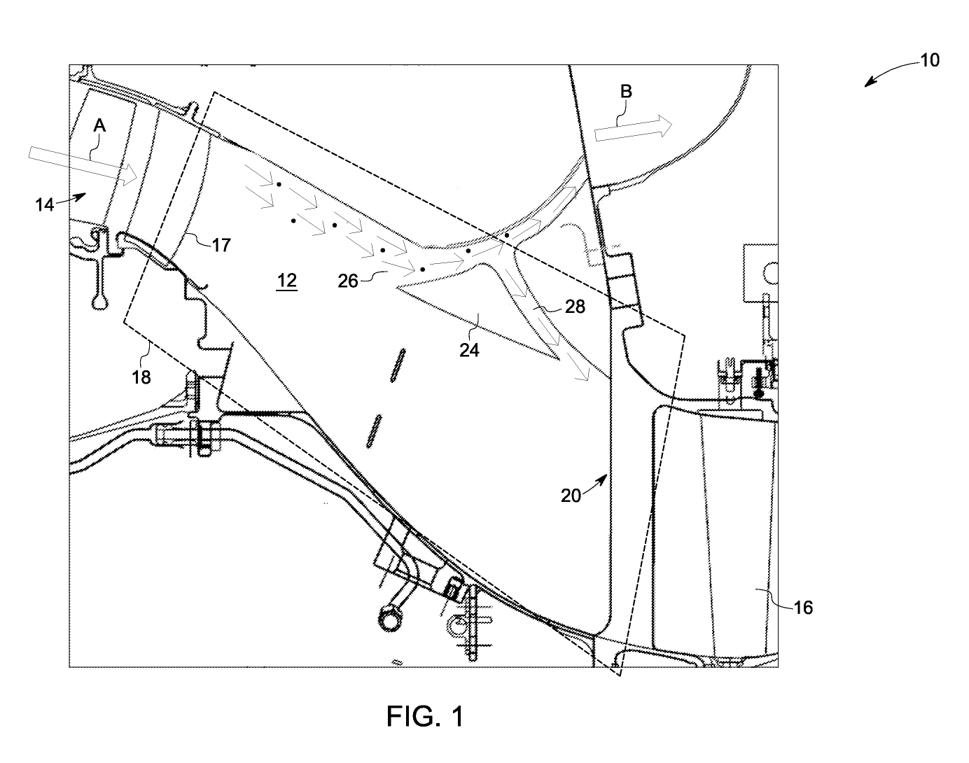

FIG. 1 is a schematic view of a section of a gas turbine engine 10 showing, a core engine flow path 12 in accordance with an example of the present technology. As shown, the core engine flow path 12 includes a fan section with a booster or a low pressure compressor 14 towards an upstream side of the gas turbine engine 10 and a high pressure compressor 16 towards downstream of the core engine flow path 12. The engine 10 also includes a fan hub frame 18 between a low pressure compressor outlet 17 and a high pressure compressor inlet 20. The core engine flow path 12 is bounded by an inner engine casing and an outer engine casing forming an annular compressor discharge. In this example, the as turbine engine includes a system for extracting foreign matter present in a primary or core engine flow A in the core engine flow path 12. The gas turbine engine 10 includes at least one wedge structure 24 disposed in the core engine flow path 12. The at least one wedge structure 24 is configured to allow a first flow into a bypass flow path through an extraction passage 26 and/or at least a second flow through a recovery passage 28 into the core engine flow path 12. In FIG. 1, the first flow is shown as arrows in the extraction passage 26 containing particulate matter highlighted as dots. The second flow (shown as arrows) in the recovery passage 28 may be a portion of the first flow that may be directed downstream into the core engine flow path. This recovery passage 28 may be provided at an end or in a middle of the extraction passage 26. In other examples, the recovery passage 28 may be provided anywhere from the start to the end of the extraction passage 26. In yet another example, the recovery passage 28 may be configured to allow the second flow into one or more engine sections of the gas turbine 10 for maintaining high efficiency for which the recovery passage 28 may be in fluid communication with one or more flow paths that direct the second flow onto one of an inlet section, a compressor section, a turbine section, a combustion section or an exhaust section of the gas turbine 10.

The wedge structure 24 is also configured to be operated to simultaneously allow both the first flow into the bypass flow path B through the extraction passage 26 and the second flow through the recovery passage 28 into the core engine flow path. Furthermore, both the first flow and the second flow through the extraction passage 26 and the recovery passage 28 respectively may be controlled by a first actuator (not shown), which allows movement of the wedge structure 24 in two degree of freedom and thereby cause the wedge structure 24 to form multiple flow path sizes of both the extraction passage 26 and the recovery passage 28.

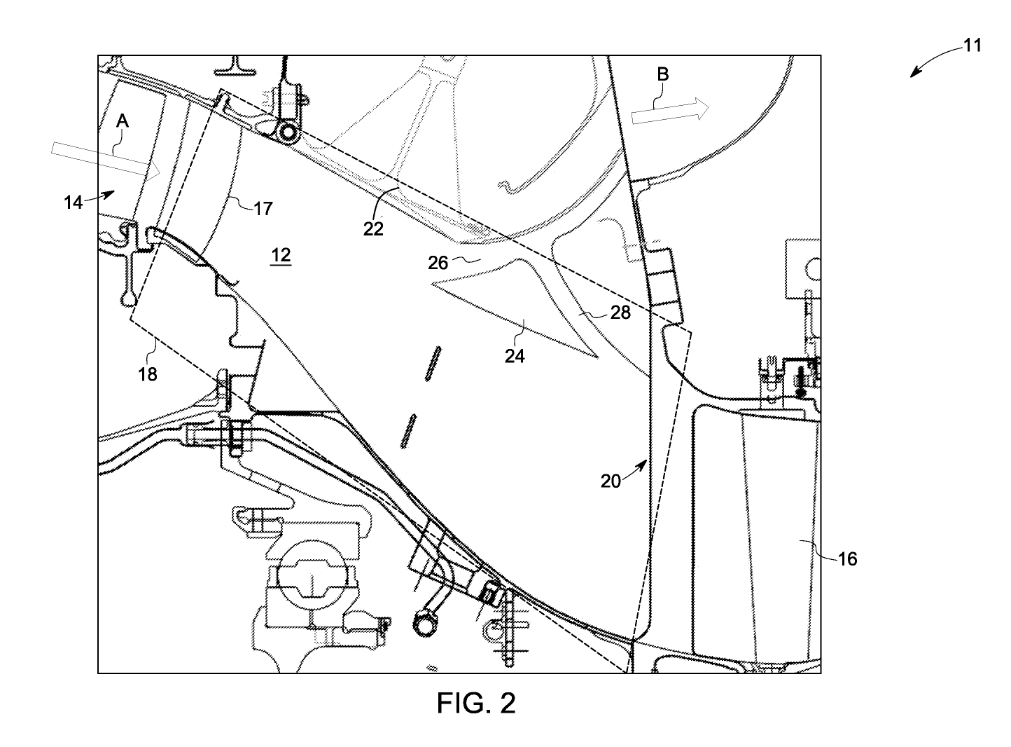

FIG. 2 is another schematic view of a section of a gas turbine engine 11 showing at least one variable bleed valve (VBV) door 22 along with the wedge structure 24 in accordance with an example of the present technology. The variable bleed valve (VBV) door 22 situated between the low pressure compressor outlet 17 and the high pressure compressor inlet 20 to allow a portion of the core engine flow and debris to leave the core engine flow path 12. Further, the gas turbine engine 11 may include multiple VBV doors 22 disposed on the outer engine casing of the fan hub frame 18 between the low pressure compressor 14 and the high pressure compressor 16 for bleeding a portion of flow from the core engine flow path 12 into a bypass section having a bypass flow path B for extracting foreign particles. It is to be noted that VBV doors 22 are configured to be operated for allowing required amount of flow in the core engine flow path 12, thereby, providing stability in the high pressure compressor 16. Each of the multiple VBV doors 22 includes operable doors which can be mechanically opened by a bleed valve torque drive rod (not shown) which can be driven by the engine 11 and controlled by appropriate sensors. It is to be noted that, a circumferential width of the wedge structure 24 may be equal to that of the VBV door 22.

In one example, both the VBV door 22 and the wedge structure 24 are configured to be actuated for extracting required core inlet flow at idling condition while the recovery passage is closed for stabilizing the compressor. The VBV door 22 may be configured to be actuated by a second actuator (not shown) for controlling the first flow into the bypass flow path. Both the first and second actuator can be linked together and include any suitable actuator that opens by the bleed valve torque drive rod (not shown) and the like which can be driven by the engine 11 and controlled by an appropriate sensors.

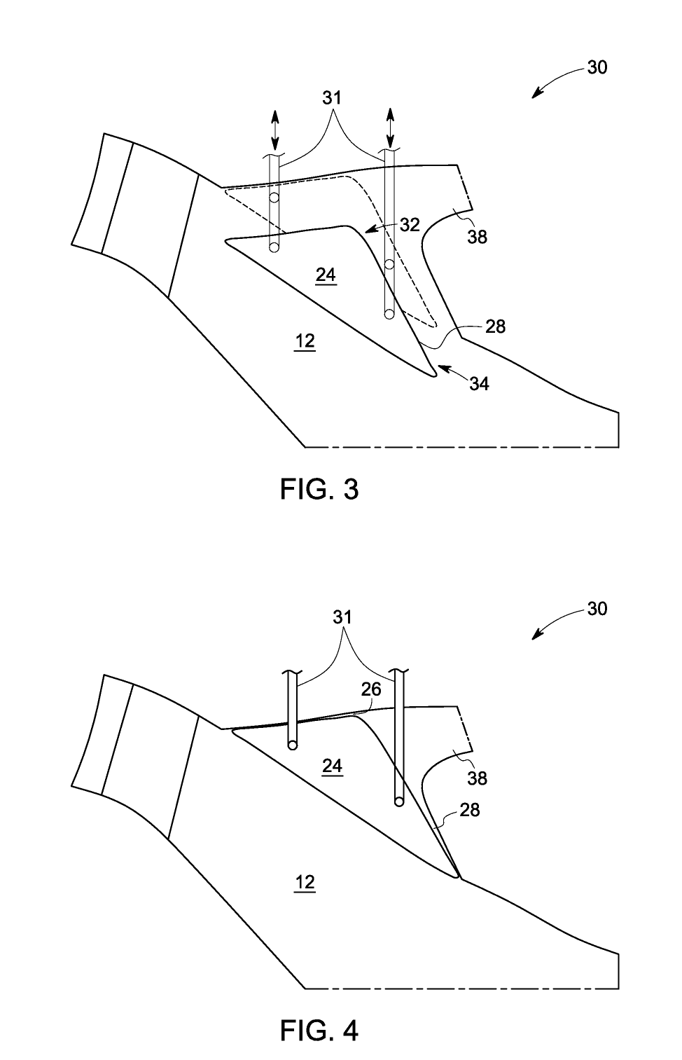

FIG. 3 shows a system 30 for extracting foreign matter in a gas turbine 10 in accordance with another example of the present technology. The system 30 shows displacement of the wedge structure 24 which is actuated by an actuator 31 to control both the first flow and the second flow through the extraction passage 26 and the recovery passage 28 in accordance with an example of the present technology. The actuator 32 is configured to control the second flow through the recovery passage 28 such that the recovery passage 28 includes a high static pressure with low fluid velocity at an inlet cross-section area 32 of the recovery passage 28 compared to a high dynamic pressure with high fluid velocity at an exit cross-section area 34 of the recovery passage 28. The actuator 31 includes multiple linkage arms that are connected with the wedge structure 24 and configured to move the wedge structure 24 such that there is required flow in the extraction passage 26 and recovery passage 28. As shown in this non-limiting example, the actuator 31 can be operated to position the wedge structure 24 in two different locations for controlling the first flow and the second flow in the extraction passage 26 and the recovery passage 28. It is to be noted that the present technology may include any suitable actuators for allowing movement of the wedge structure 24 in two degree of freedom and thereby cause the wedge structure 24 to form multiple flow path sizes of both the extraction passage 26 and the recovery passage 28. In another example, FIG. 4 shows displacement of the wedge structure 24 which is actuated by an actuator 31 to control both the first flow and the second flow through the extraction passage 26 and the recovery passage 28 in accordance with an example of the present technology.

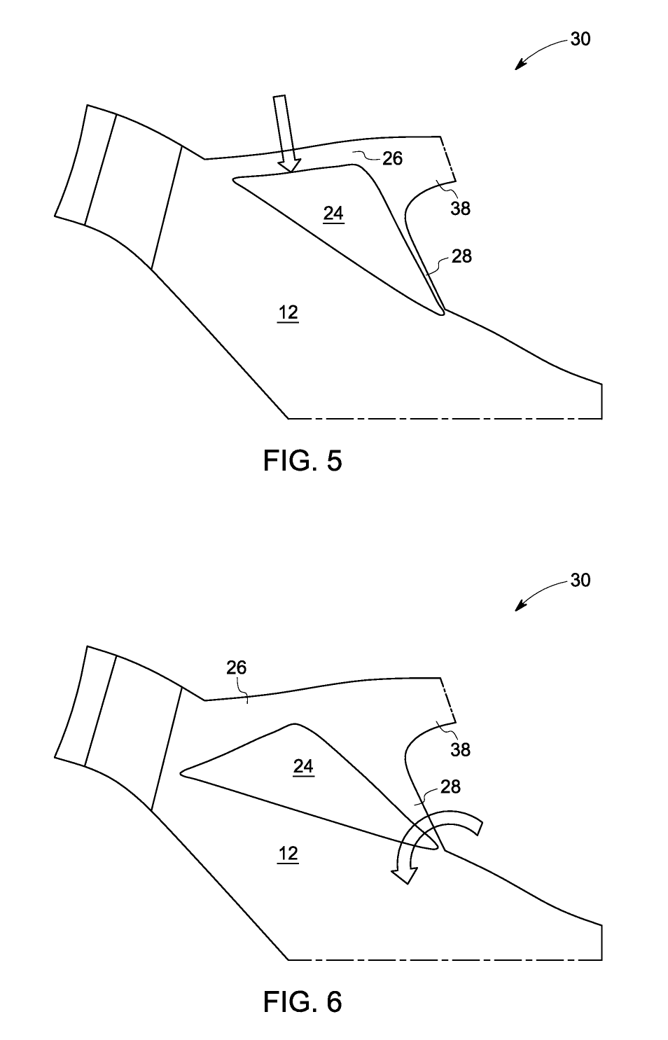

In yet another example, FIG. 5 shows displacement of the wedge structure 24 which is actuated by the actuator (not shown) to control only the second flow through the recovery passage 28, thereby, allowing the first flow into the flow path 38 and further into the bypass flow path (not shown) for extraction of foreign particles in accordance with an example of the present technology.

Further, in another example, FIG. 6 shows the wedge structure 24 hinged at a downstream end of the core engine flow path such that the wedge structure 24 is configured to be actuated to control the first flow through the extraction passage 26 and further into the into the bypass flow path via the flow path 38 for extraction of foreign particles.

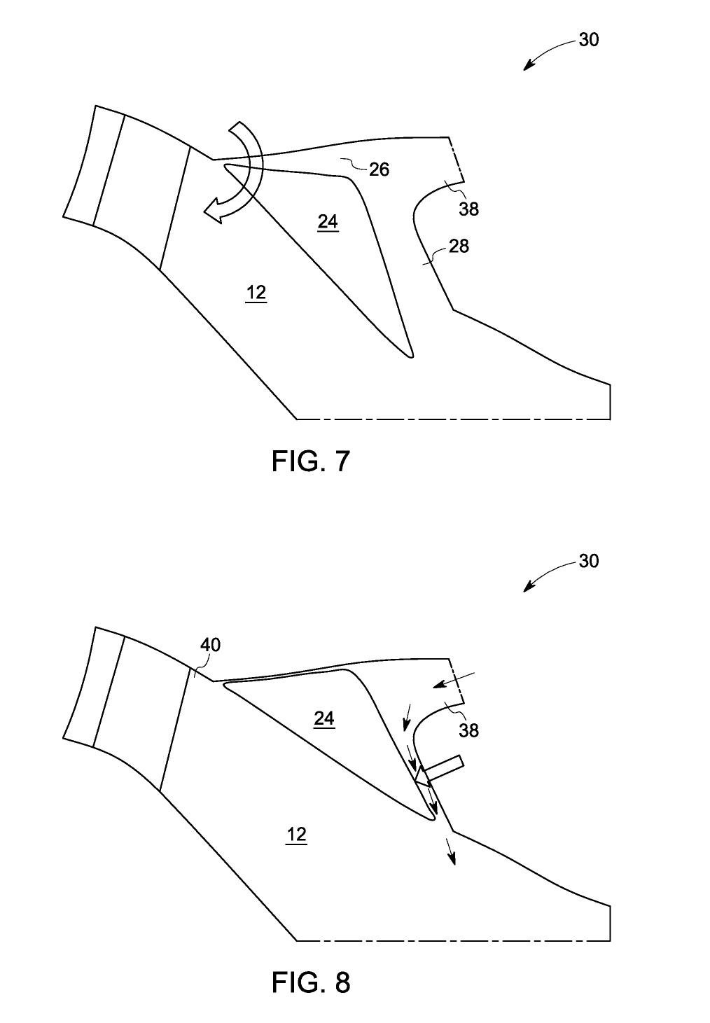

In one example, FIG. 7 shows the wedge structure 24 hinged at an upstream end of the core engine flow path such that the wedge structure 24 is configured to be actuated to control the second flow through the recovery passage 26.

Furthermore, in another example as shown in FIG. 8, when the core engine flow path 12 is choked at an inlet 40, the wedge structure 24 may be actuated such that the wedge structure 24 closes the extraction passage 26 to allow a reverse flow of fluid from the bypass flow path via the recovery passage 28 into the high pressure compressor 16 (as shown in FIG. 1).

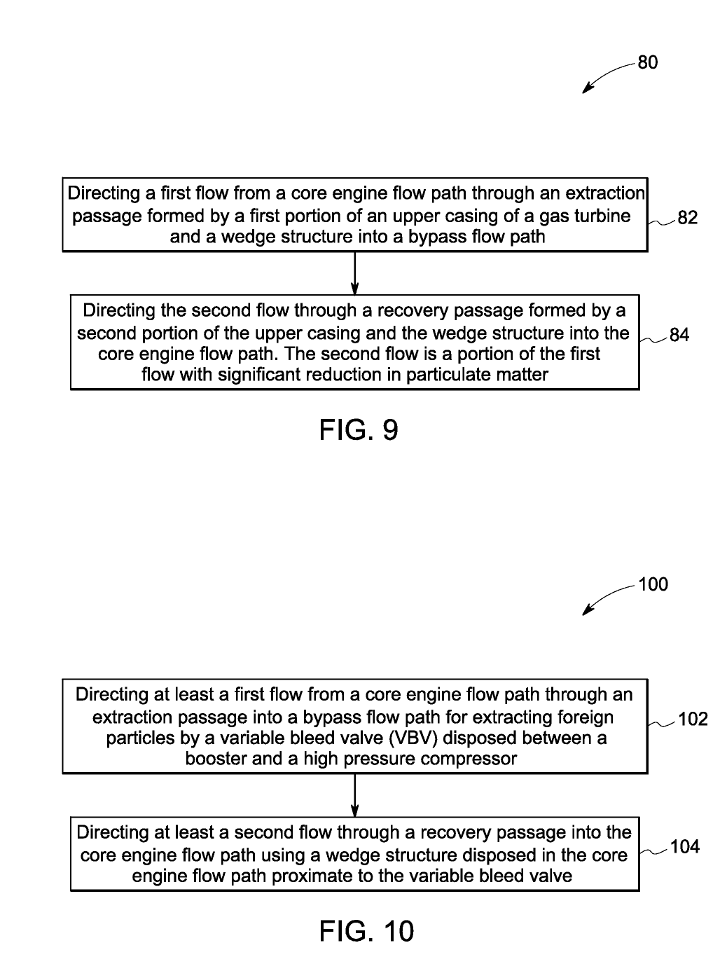

FIG. 9 is a flow chart 80 of a method of extracting foreign particles by a gas turbine engine in accordance with an example of the present technology. At step 82, the method includes directing a first flow from a core engine flow path through an extraction passage formed by a first portion of an upper casing of a gas turbine and a wedge structure into a bypass flow path. The wedge structure is disposed in the core engine flow path between a booster and a high pressure compressor. At step 84, the method includes directing the second flow through a recovery passage formed by a second portion of the upper casing and the wedge structure into the core engine flow path. The second flow is a portion of the first flow with significant reduction in particulate matter. The method further includes controlling the first flow though the extraction passage and the second flow through the recovery passage by actuating the wedge structure using one or more actuators. The method also includes directing a reverse flow of fluid flow from the bypass flow path via the recovery passage and further into the compressor when the core engine flow path is choked at an inlet. The wedge structure may include two degrees of freedom for allowing a plurality of cross-section area of the extraction passage and the recovery passage for controlling fluid flows.

FIG. 10 is a flow chart 100 of a method of extracting foreign particles by a gas turbine engine in accordance with an example of the present technology. At step 102, the method includes directing at least a first flow from a core engine flow path through an extraction passage into a bypass flow path for extracting foreign particles by a variable bleed valve (VBV) disposed between a booster and a high pressure compressor. At step 104, the method also includes directing at least a second flow through a recovery passage into the core engine flow path using a wedge structure disposed in the core engine flow path proximate to the variable bleed valve. The second flow is a portion of the first flow with significant reduction in particulate matter. Further, the method includes controlling the at least first flow though the extraction passage by actuating both the wedge structure and the variable bleed valve using a first actuator and a second actuator respectively, wherein both the first actuator and the second actuator are linked together. Furthermore, in one example, the method includes controlling the at least second flow through the recovery passage by actuating both the wedge structure and the variable bleed valve using the first actuator and the second actuator respectively. The method also includes directing a reverse flow of fluid flow from the bypass flow path via the recovery passage and further into the high pressure compressor when the core engine flow path is choked at an inlet. It is to be noted that the wedge structure includes two degrees of freedom for allowing a plurality of cross-section area of the extraction passage and the recovery passage for controlling fluid flows.

In another example, a method of extracting foreign particles by a gas turbine engine includes directing at least a first flow from a core engine flow path through an extraction passage formed between the casing and a wedge structure into a bypass flow path for extracting foreign particles. The method also includes directing at least a second flow through a recovery passage into the core engine flow path using the wedge structure disposed in the core engine flow path proximate to the casing between a low pressure compressor and a high pressure compressor within a fan hub frame. The second flow is a portion of the first flow and contains reduced particulate matter. Further, the method includes controlling the at least first flow and the second flow though the extraction passage and the recovery passage respectively by actuating the wedge structure using a first actuator and a second actuator respectively, wherein both the first actuator and the second actuator are linked together. The method also includes directing a reverse flow of fluid flow from the bypass flow path via the recovery passage and further into the high pressure compressor when the core engine flow path is choked at an inlet. It is to be noted that the wedge structure includes two degrees of freedom for allowing a plurality of cross-section area of the extraction passage and the recovery passage for controlling fluid flows.

Advantageously, the present technology is directed towards improving extraction of the foreign particles from core engine flow path of the gas turbine engine. The extraction efficiency may improve by about 10% which may lead to 30% reduction of foreign matter ingestion in the high pressure compressor. Further, this may result in improved operability and durability of the gas turbine engine. Furthermore, the present invention results in improvement in scheduled product service and maintenance leading to cost saving. Further, the present technology leads to higher extraction with less VBV door opening as bleed flow is recovered back through the recovery passage. Moreover, the present technology reduces risk of harsh environment operability.

Furthermore, the skilled artisan will recognize the interchangeability of various features from different examples. Similarly, the various methods and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular example. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While only certain features of the technology have been illustrated and described herein, many modifications and changes will occur to those skilled in the art. It is, therefore, to be understood that the appended claims are intended to cover all such modifications and changes as fall within the true spirit of the claimed inventions.

1. A system for extracting foreign matter in a gas turbine, the system comprising:
a wedge structure disposed in the core engine flow path between a low pressure compressor and a high pressure compressor and disposed within a fan hub frame;
an extraction passage formed by a first portion of an upper casing and the wedge structure configured to allow a first flow into a bypass flow path for extraction of foreign particles; and
a recovery passage formed by a second portion of the upper casing and the wedge structure configured to allow a second flow into the core engine flow path.

2. The system of claim 1, wherein the second flow comprises a portion of the first flow.

3. The system of claim 1, wherein the recovery passage is provided between a beginning and an end of the extraction passage.

4. The system of claim 1, wherein the wedge structure is configured to be actuated to control the first flow through the extraction passage and the second flow through the recovery passage into the core engine flow path.

5. The system of claim 1, wherein the wedge structure is hinged at a downstream end of the core engine flow path such that the wedge structure is configured to be actuated to control the first flow through the extraction passage and further into the bypass flow path for extraction of foreign particles.

6. The system of claim 1, wherein the wedge structure is hinged at an upstream end of the core engine flow path such that the wedge structure is configured to be actuated to control the second flow through the recovery passage.

7. The system of claim 1, wherein the wedge structure is configured to be actuated to open the recovery passage to allow a reverse flow of fluid from the bypass flow path via the recovery passage into the compressor when the core engine flow path is choked at an inlet.

8. A method comprising:
directing at least a first flow from a core engine flow path through an extraction passage formed by a first portion of an upper casing of a gas turbine and a wedge structure into a bypass flow path, wherein the wedge structure is disposed in the core engine flow path between a booster and a high pressure compressor; and
directing at least a second flow through a recovery passage formed by a second portion of the upper casing and the wedge structure into the core engine flow path.

9. The method of claim 8, further comprising directing the second flow into one or more engine sections of the gas turbine.

10. The method of claim 8, further comprising controlling the first flow though the extraction passage and the second flow through the recovery passage by actuating the wedge structure using one or more actuators.

11. The method of claim 8, further comprising directing a reverse flow of fluid flow from the bypass flow path via the recovery passage and further into the compressor when the core engine flow path is choked at an inlet.

12. The method of claim 8, further comprising bleeding the first flow from the core engine flow path into a bypass flow path by a variable bleed valve disposed between a booster and a high pressure compressor of a gas turbine proximate to the wedge structure for extracting foreign particles.

13. The method of claim 12, further comprising controlling both the first flow and the second flow by actuating both the wedge structure and the variable bleed valve using a plurality of actuators.

14. The method of claim 8, wherein the wedge structure comprises two degrees of freedom for allowing a plurality of cross-section area of the extraction passage and the recovery passage for controlling fluid flows.

15. A system for extracting foreign matter in a gas turbine, the system comprising:
at least one variable bleed valve disposed between a booster and a high pressure compressor configured to bleed at least a first flow from a core engine flow path into a bypass flow path configured to extract foreign particles, and
at least one wedge structure disposed in the core engine flowpath proximate to the variable bleed valve and configured to allow the first flow into the bypass flow path through an extraction passage or at least a second flow through a recovery passage into the core engine flow path.

16. The system of claim 15, wherein the wedge structure is configured to be operated to simultaneously allow both the first flow into the bypass flow path through the extraction passage and the second flow through the recovery passage into the core engine flow path.

17. The system of claim 15, wherein both the variable bleed valve and the wedge structure are configured to be actuated independently to control the first flow into the bypass flow path through an extraction passage or the second flow through the recovery passage.

18. The system of claim 15, wherein both the variable bleed valve and the wedge structure are configured to be actuated to extract required optimal core inlet flow at idling condition while the recovery passage is closed to stabilize the compressor.

19. A variable bleed valve system comprising:
a variable bleed valve door disposed between a booster and a high pressure compressor of a gas turbine configured to bleed at least a first flow from a core engine flow path into a bypass flow path to extract foreign particles; and
a wedge structure disposed in the core engine flowpath proximate to the variable bleed valve configured to control fluid flows in one or more passages formed by the wedge structure with a section of the gas turbine and the variable bleed valve door; wherein the one or more passages comprises
an extraction passage configured to extract particulate matter by allowing at least the first flow into the bypass flow path, and
a recovery passage configured to allow at least a second flow into one or more engine sections of the gas turbine, wherein the second flow is a portion of the first flow that is redirected into the core engine flow path.

20. The variable bleed valve system of claim 19, wherein the recovery passage is in fluid communication with one or more flow paths that direct the second flow into the one or more engine sections comprising an inlet section, a compressor section, a combustion section, a turbine section and an exhaust section.

21. The variable bleed valve system of claim 19, wherein the wedge structure is configured to be actuated by a first actuator configured to control the second flow through the recovery passage.

22. The variable bleed valve system of claim 21, wherein the wedge structure is actuated by the first actuator such that the recovery passage includes a high static pressure with low fluid velocity at an inlet cross-section area of the recovery passage compared to a high dynamic pressure with high fluid velocity at an exit cross-section area of the recovery passage.

23. The variable bleed valve system of claim 19, wherein the variable bleed valve door is configured to be actuated by a second actuator configured to control the at least first flow into the bypass flow path through an extraction passage.
